(19) United States
(12) Patent Application Publication
(10) Pub. No.: US 2008/0225562 A1
(43) Pub. Date: Sep. 18, 2008

(54) ELECTRICAL POWER CONVERSION SYSTEM FOR COMMERCIAL AND RESIDENTIAL APPLICATIONS

(76) Inventors: Ahmed Mashra, Dearborn, MI (US); Robert A. Pasek, Troy, MI (US)

Correspondence Address: HARNESS, DICKEY & PIERCE, P.L.C., P.O. BOX 828, BLOOMFIELD HILLS, MI, 48303, US

(21) Appl. No.: 11/685,278

(22) Filed: Mar. 13, 2007

(51) Int. Cl. H02M 1/20; H02K 53/00

(52) U.S. Cl. 363/102; 74/DIG. 9

(57) ABSTRACT

A power conversion circuit includes main terminals that receive a first electrical energy from a main power source. An electric motor has input terminals that are coupled to the main terminals. The electric motor receives a second electrical energy as a current input based on the first electrical energy and converts the electrical energy into mechanical energy to generate a mechanical output. An electric generator generates a current output, which is greater than or equal to the current input, based on the mechanical output. Distribution terminals are coupled to a distribution circuit of a building and receive the current output. Voltage across the input terminals is approximately equal to voltage across the distribution terminals.

### FIELD

The present disclosure relates to electrical power conversion and distribution systems, and more particularly to power conservation techniques associated with the same.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Electrical energy consumption, in general, continues to increase throughout the world in residential, commercial and industrial settings. For example, despite technological improvements, many lifestyle changes have put higher demands on heating and cooling resources. For example, the average size of homes built in the United States has increased significantly.

Electrical power is typically generated in central locations and distributed to consumers. Large generators are spun to generate electricity. The generators may be spun via a hydroelectric dam, a diesel engine, a gas turbine, a steam turbine or via some other rotating power source. Fossil fuel resources, such as coal, oil and natural gas, may be used to spin the generators. Rotational energy may also come from a nuclear reactor.

The continuous increase in electrical energy consumption increases demand on existing power generation and supply facilities and electrical distribution networks. Also, fossil fuel resources are in high demand. Thus, the costs of electrical energy are ever increasing.

Energy conservation is often the most economical solution to energy shortages, and is a more environmentally benign alternative to increased energy production. Energy conservation facilitates the replacement of non-renewable resources with renewable energy. Energy conservation can also result in reduced emissions. Energy conservation can reduce the need for new power plants and energy imports. Reduced energy demand can also provide more flexibility in choosing methods of energy production.

Various energy conservation and efficiency improvements have been developed. The improvements have been developed to reduce energy costs and promote economic, political and environmental stability. The improvements include power plant efficiencies, distribution network efficiencies, as well as efficiencies in consumer electronics, machines and devices. Although these improvements provide some relief, they are limited. Also, it may be difficult for home owners or small business to justify investment in some of the energy saving measures.

### SUMMARY

A power conversion circuit is provided that includes main terminals that receive a first electrical energy from a main power source. An electric motor has input terminals that are coupled to the main terminals. The electric motor receives a second electrical energy as a current input based on the first electrical energy and converts the electrical energy into mechanical energy to generate a mechanical output. An electric generator generates a current output, which is greater than or equal to the current input, based on the mechanical output. Distribution terminals are coupled to a distribution circuit of a building and receive the current output. Voltage across the input terminals is approximately equal to voltage across the distribution terminals.

A power conversion system is also provided that includes a switch over circuit that receives an electrical energy from a power source and that operates in a first mode and a second mode based on load of a distribution circuit. An electric motor has input terminals. The electric motor receives at least a portion of the electrical energy as a current input when the switch over circuit is in the first mode. The electric motor converts the electrical energy into mechanical energy to generate a mechanical output. An electric generator generates a current output, which is greater than or equal to the current input, based on the mechanical output. Distribution terminals are coupled to the distribution circuit and receive at least a portion of the electrical energy when the switch over circuit is in the second mode.

A power conversion circuit is further provided and includes a control module that generates a switch over signal based on load of a distribution circuit. A switch over circuit receives a first electrical energy from a main power source and that operates in a first mode and a second mode based on the switch over signal. A motor drive circuit generates a second electrical energy based on at least a portion of the first electrical energy when the switch over circuit is in the first mode. An electric motor has input terminals, which receive said second electrical energy as a current input, and converts the second electrical energy into mechanical energy to generate a mechanical output. An electric generator generates a current output, which is greater than or equal to the current input, based on the mechanical output. Distribution terminals are coupled to the distribution circuit and receive the first electrical energy, when the switch over circuit is in the second mode.

The embodiments disclosed herein provide several advantages. One advantage is the inclusion of a power conversion circuit that provides an increased current output. This allows a distribution circuit to receive a current input that is greater than a current draw from a main power source. The current increase may be provided when voltage of the main power source and voltage at the current output or to the distribution circuit are the same. In other words, with respect to a consumer implementation, power received by consumer electrical circuits is greater than power drawn from a main power source. Thus, the embodiments provide power conservation without a decrease in power output. The power conservation reduces costs to the consumer and drain on a power distribution network. When applied to a power distribution network, the power conservation reduces power requirements of utility companies, power plants, power stations, etc. without decreased power output. The embodiments efficiently operating and cost effective power conversion systems and circuits for various applications.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a power conversion system in accordance with an embodiment of the present disclosure;

FIG. 2 is a functional block diagram of a power conversion system in accordance with another embodiment of the present disclosure;

FIG. 3 is a functional block and schematic diagram of a power conversion circuit in accordance with an embodiment of the present disclosure;

FIG. 4 is a schematic view of an AC-to-DC converter in accordance with an embodiment of the present disclosure;

FIG. 5 is a is a schematic view of an DC-to-AC converter in accordance with an embodiment of the present disclosure;

FIG. 6 is a functional block diagram of a power conversion system incorporating a mechanical generator in accordance with another embodiment of the present disclosure;

FIG. 7 is a functional block diagram of a multi-power conversion system in accordance with another embodiment of the present disclosure;

FIG. 8 is a functional block diagram of a consumer electrical power distribution network with a portion thereof that incorporates a power conversion circuit in accordance with another embodiment of the present disclosure; and

FIG. 9 is a logic flow diagram illustrating a method of operating a power conversion system in accordance with another embodiment of the present disclosure.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to a contactor, an Application Specific Integrated Circuit (ASIC), an electronic circuit, a processor (shared, dedicated, or group) and memory that execute one or more software or firmware programs, a combinational logic circuit, and/or other suitable components that provide the described functionality.

The embodiments disclosed herein may be applied in residential, commercial, and industrial sectors, as well as in other sectors. The residential sector may include homes, apartments, dormitories and other dwellings. The commercial sector may include retail stores, offices (business and government), restaurants, schools and other workplaces. The industrial sector may include any production and processing facility for goods, as well as manufacturing, construction, farming, water management and mining related facilities.

The embodiments disclosed herein may also be applied to power distribution networks, utility networks, power generation facilities and sites, and other electricity generating and distributing networks and places.

In the following description the term “building” may refer to any architectural structure. As a couple of examples, a building may refer a residential home, a shop, and an office. A building refers to a structure that receives power, which may be metered, and upon reception thereof distributes such power throughout the structure. The distributed power may be used to power electrical fixtures, outlets, or other electrical device or circuits. The distributed power may be used to power lights, appliances, machines, motors, air conditioning units, heating units, etc.

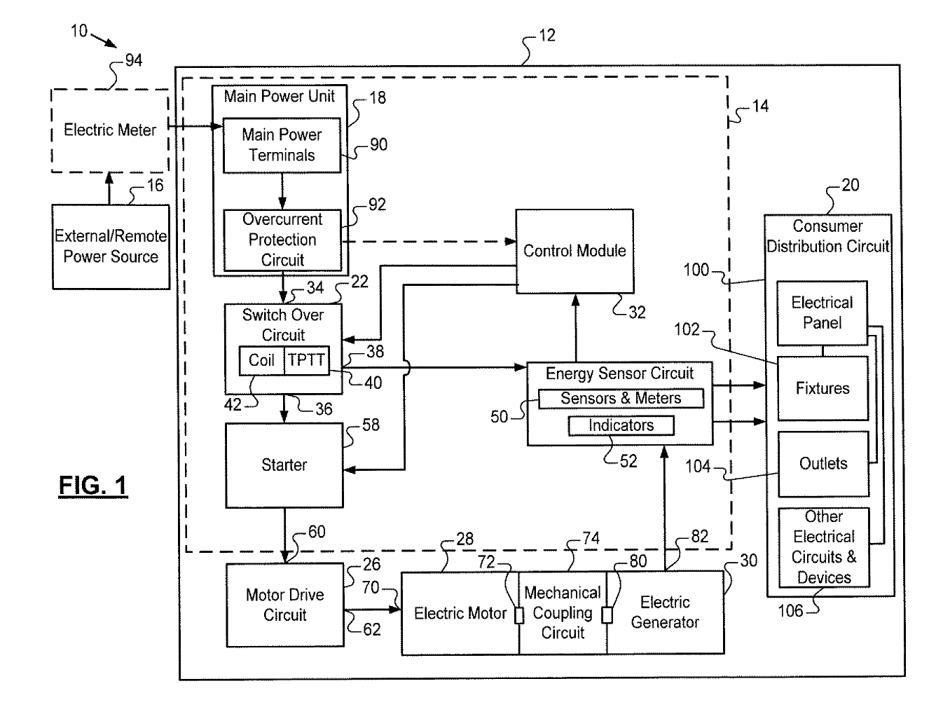

Referring now to FIG. 1, a functional block diagram of a power conversion system 10 of a building 12 is shown. The power conversion system 10 includes a power conversion circuit 14 that receives electrical power from an external/remote main power source 16 via main power unit 18. The power source 16 may refer to a transformer, a power station, a power line, a power generator, an independently operated generator, or some other power source. The power conversion system 10 provides increased power output over that received by the power source 16 to supply a consumer distribution circuit 20.

The power conversion circuit 14 includes a switch over circuit 22 that provides power directly to the distribution circuit 20, through an energy sensor circuit 24, or indirectly via a motor drive circuit 26, an electric motor 28, an electric generator 30 and the energy sensor circuit 24. A control module 32 is coupled between the switch over circuit 22 and the sensor circuit 24. The control module 32 controls the switch over circuit 22 based on electrical energy provided to the distribution circuit 20.

The switch over circuit 22 has a switch circuit input 34, a first switch circuit output 36 and a second switch circuit output 38. The switch over circuit 22 may include one or more switches, contactors, or other electrical components or devices to switch current flow from the switch circuit input 34 to either of the first or second switch circuit outputs 36, 38. The switch over circuit 22 may also include isolation circuits, buffers, or other isolation and/or separation components or devices to separate the first and second circuit outputs 36, 38. The switch over circuit 22 may also include overloads and other circuit protection components.

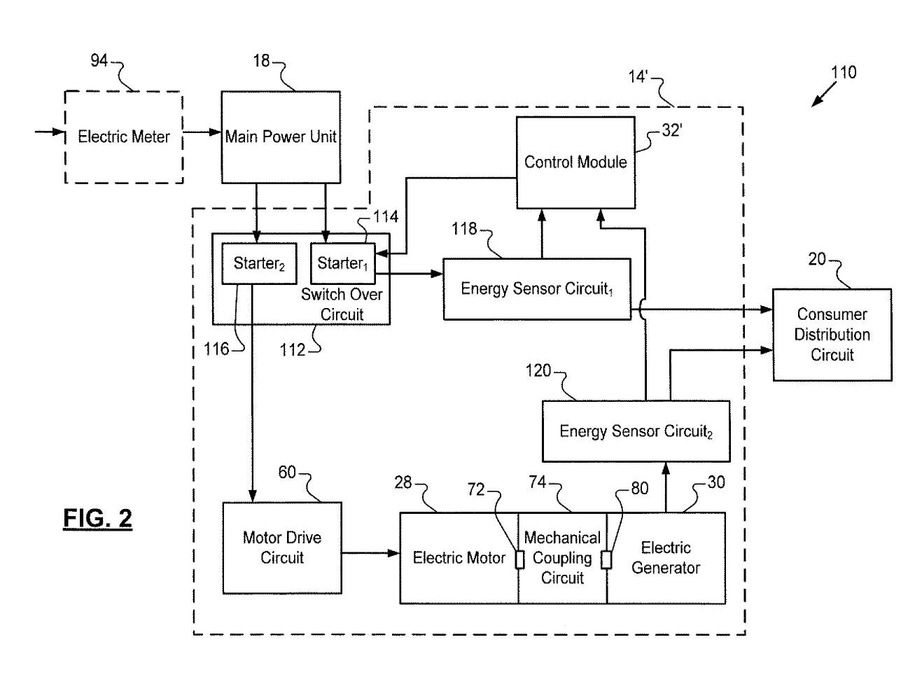

In the embodiment of FIG. 1, the switch over circuit 22 includes a triple pole triple throw (TPTT) switch 40, whereby each common terminal thereof is coupled to a respective input phase line of the switch circuit input 34. The non-common terminals of the TPTT switch 40 are coupled to respective output phase lines of the switch circuit outputs 36, 38. The switch over circuit 22 may include a coil 42 that is energized to change state of the TPTT switch 40. Another example embodiment is shown with respect to FIG. 2, in which a switch over circuit includes multiple starters.

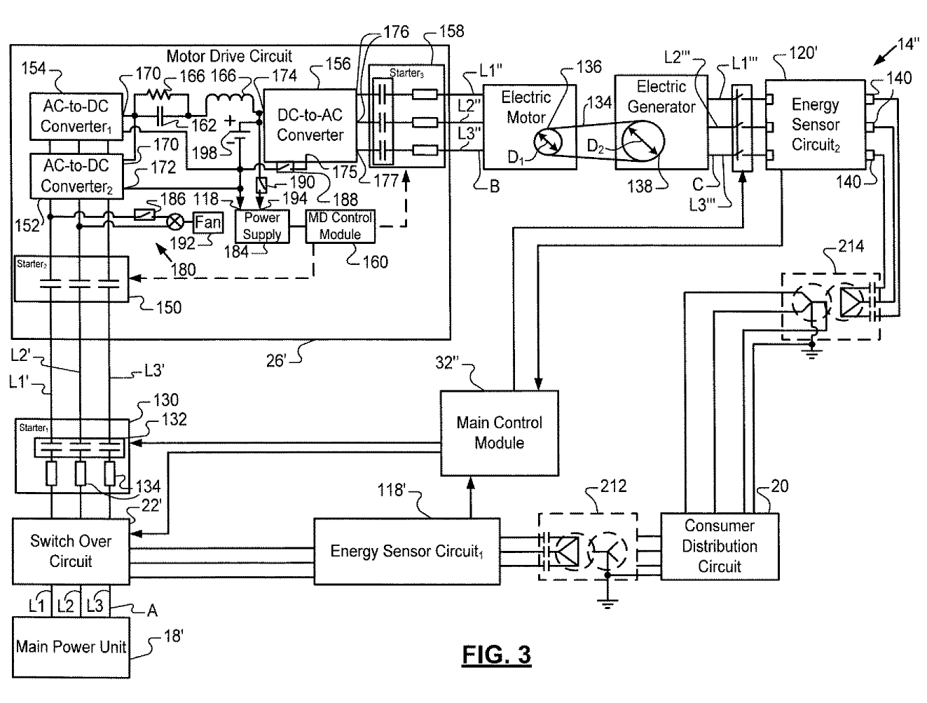

The energy sensor circuit 24 may include various sensors and meters 50, such as voltage, current and power sensors and meters. In one embodiment, one or more current sensors are used to detect current flow on one or more phase legs out of the switch over circuit 22 and/or of the main power unit 18. The current sensed is provided to the control module 32 for control of the switch over circuit 22. The energy sensor circuit 24 may include one or more indicators 52, such as gauges, meters, or other energy indicators. Note that although one energy sensor circuit is shown, any number of which may be utilized. The embodiments of FIGS. 2 and 3 provide example of two-energy sensor circuit implementations.

The motor drive circuit 26 is coupled to the switch over circuit 22 via a starter 58. The motor drive circuit 26 has a motor drive input 60 and a motor drive output 62. The motor drive output 62 is an adjustable voltage/frequency three phase alternating current (AC) output, which is ramped up and supplied to the electric motor 28. The motor drive circuit 26 may include a motor drive, such as a motor drive by MagneTek, Inc. that has headquarters in Menomonee Falls, Wis. An example motor drive is the motor drive that has serial number or identification GPD 505 by MagneTek. Of course, other motor drives may be incorporated. A more detailed example of a motor drive circuit is provided and described with respect to the embodiment of FIG. 3. The motor drive circuit 26 may receive conventional 120v, 240v, or 480v three phase AC power or may be configured to receive some other electrical energy convension.

The electric motor 28 has an electric motor input 70 and a first mechanical output 72. The electric motor 28 converts electrical energy into mechanical energy. The electric motor 28 may also receive conventional 120v, 240v, or 480v three phase AC power or may receive some other energy convension. A mechanical coupling assembly 74 mechanically couples the electric motor 28 to the electric generator 30. The mechanical coupling assembly 74 may include gears, pulleys, belts, chains, and/or other mechanical coupled elements. An example of which is shown in FIG. 3. The mechanical coupling assembly 74 may have an associated pulley or gear ratio between the electric motor 28 and the electric generator 30. As an alternative, the electric motor 28 may be directly coupled to the electric generator 30, without use of the coupling assembly 74. Also, note that the electric motor 28 may be coupled directly to the main power unit 18, without use of the motor drive circuit 26.

The electric generator 30 has a mechanical input 80 and an electrical output 82. The electric generator 30 converts mechanical energy into electrical energy. The mechanical input 80 is coupled to the mechanical output 82 via the mechanical coupling assembly 74. The electric generator 30 may generate conventional 120v, 240v, or 480v three phase AC power or may generate power in some other energy convension. In one embodiment, the electric generator 30 generates AC power that has the same convention as the electric motor 28. In another embodiment, the current received by the motor drive circuit 26 and provided to the electric motor 28 are at approximately the same voltage level. In a further embodiment, the current received by the motor drive circuit 26 and provided to the electric motor 28, and outputted by the electric generator 30 are at approximately the same voltage level. In yet other embodiments, the voltage conventions of the motor drive circuit 26, the electric motor 28 and the electric generator 30 are different.

The control module 32 controls operation of the switch over circuit 22 and the starter 58. The control module 32 may be part of the switch over circuit 22, the energy sensor circuit 24, the starter 58, or may be a stand alone module as shown. The control module 32 may be microprocessor based such as a computer having a central processing unit, memory (RAM and/or ROM), and associated input and output buses. The control module 32 may be application-specific integrated circuit or may be formed of other logic devices known in the art. The control module 32 may be a portion of a central main control unit, an interactive module, a main safety control module, a control circuit having a power supply, or may be combined into a single integrated control module.

The main power unit 18 includes main power terminals 90 and an overcurrent circuit 92. The main power unit 18 serves as the first point of electrical power reception within the building 12. An electric meter 94 may meter the power received by the main power unit 18, as shown. The overcurrent protection circuit 92 may include fuses, circuit breakers, arc fault interrupt circuits, or other circuit protective devices.

The distribution circuit 20 may include an electrical panel 100 with circuit breakers and/or other circuit protection devices. Power is distributed from the electrical panel 100 to fixtures 102, electrical outlets 104, and other electrical circuits and devices 106.

Referring now to FIG. 2, a functional block diagram of a power conversion system 110 is shown. The power conversion system 110 is similar to the power conversion system 10. The power conversion system 110 includes a power conversion circuit 14′ with a switch over circuit 112. The switch over circuit 112 includes a pair of starters 114, 116, as opposed to a TPTT. The starters 114, 116 may include contactors, overloads, and other starter elements. Example starters are shown in FIG. 3.

The power conversion circuit 14′ also includes two energy sensor circuits 118, 120. A first energy sensor circuit 118 is coupled between the first starter 114 and the distribution circuit 20. The second energy sensor circuit 120 is coupled between the electric generator 30 and the distribution circuit 20.

The power conversion circuit 14′ further includes a control module 32′, which is similar to the control module 32. The control module 32′ is coupled to the switch over circuit 112 and the energy sensor circuits 118, 120.

Referring now to FIG. 3, a functional block and schematic diagram of a power conversion circuit 14″ is shown. The power conversion circuit 14″ receives electrical power from an external/remote power source via the main power unit 18 and provides power to the consumer distribution circuit 20. The power conversion circuit 14″ includes a main control module 32″, a switch over circuit 22′, a motor drive circuit 26′, an electric motor 28′, an electric generator 30′, and, as shown, two energy sensor circuits 118′, 120′.

The main control module 32″, is similar to the control module 32, and is coupled to each of the energy sensor circuits 118′, 120′ and controls operation of the switch over circuit 22′ and a first starter 130. The switch over circuit 22′ is coupled to the first starter 130, which in turn is coupled to the motor drive circuit 26′. The first starter 130 may include a contactor 132 and overloads 134, as shown, or other starter elements, such as single phase preventers, dashpots, and fuses. A single phase preventer refers to a device that trips one or more phase legs when another phase leg is missing, not providing proper current, or has an improper voltage potential. In use, the switch over circuit 22′ switches current flow from the main power unit 18′ to either the first energy sensor circuit 118′ or the first starter 130. The main power unit 18′ has phase legs L1-L3.

The motor drive circuit 26′ ramps up current and/or voltage output to the electric motor 28′. As an example, the motor drive circuit 26′ may ramp the voltage output from 0-240v. This ramp up provides a smooth increase in the speed of the electric motor 28′. The motor drive circuit 26′ also controls frequency of the electrical energy supplied to the electric motor 28′. As another example, the motor drive circuit 26′ may maintain frequency of the electrical energy at approximately 61 Hz±2 Hz.

The electric motor 28′ is coupled to the electric generator 30′ via a pulley coupling assembly 134. The pulley coupling assembly 134 includes first and second pulleys 136, 138, which are respectively, coupled to the electric motor 28′ and electric generator 30′. In the shown embodiment, the first pulley 136 is smaller than the second pulley 138, which provides flexibility in adjusting speed on the electric generator 30′. The first and second pulleys 136, 138 have rotating diameters D1 and D2. In one embodiment, the pulley ratio D1:D2 is approximately 1:2. As another example, the pulley ratio D1:D2 may be approximately 12:23.

When calibrating the motor dive circuit 26′ based on the intended load of the distribution circuit 20, output flexibility of the electric motor 28′ allows for speed adjustment on the electric generator 30′. The ability to adjust the speed of the electric generator 30′, allows for maintenance of a predetermined frequency or frequency range when the load of the distribution circuit 20 is altered. An example maintained frequency range is 60-65 Hz. Of course, other frequency settings may be maintained.

The electric generator 30′ and/or the second energy sensor circuit 120′ may have consumer distribution terminals. The distribution terminals provide power from the electric generator 30′ to the distribution circuit 20. For the embodiment shown, consumer distribution terminals 140 are mounted on the second energy sensor circuit 120′.

The motor drive circuit 26′ includes a second starter 150, two AC-to-DC (A/D) converters 152, 154, a DC-to-AC (D/A) converter 156 and a third starter 158. Operation of the starters 150, 158 is controlled by a motor drive control module 160. The starters 150, 158 may also include contactors, overloads, or other starter elements. The first and second A/D converters 152, 154 are coupled in parallel and receive current from input legs L1′-L3′ and generate DC current that is provided to the D/A converter 156 via a capacitor 162 and inductor 164. The capacitor 162 and the inductor 164 are coupled in series. A resistor 166 is coupled in parallel with the capacitor 162. The capacitor 162, inductor 164, and resistor 166 provide stability. The A/D converters 152, 154 have respective positive and negative A/D converter output terminals 170, 172. The D/A converter 156 has positive and negative DC inputs 174, 175 and AC outputs 176, 177.

The motor drive circuit 26′ also includes one or more cooling fan circuits 180, a power source 182, a power supply 184, and one or more thermal switches 186, 188, 190. The motor drive control module 160 controls operation of the motor drive circuit 26′ and receives power from the power supply 184. The motor drive control module 160 ramps up current/voltage supplied to the legs L1″-L3″. As shown, a cooling fan 192 is coupled to first and second legs L1′, L2′ and cools the power supply 184. The power supply 184 has positive and negative power supply input terminals 194, 196. The power supply 184 receives DC power from the A/D converters 152, 154 and/or a power source 198 and supplies power to the motor drive control module 160. The power source 198 is coupled between the positive DC input 174 and the negative power supply input 196. A second cooling circuit may be incorporated to cool the motor drive control module 160.

For example purposes only, three thermal switches are included. The first thermal switch 186 is coupled between the first leg L1′ and the fan 192. A second thermal switch 188 is coupled between the negative terminals 172 and the negative DC input 175. A third thermal switch 190 is coupled between the positive DC input 174 and the positive power supply input 194.

The power conversion circuit 14″ may also include a cutoff switch 210 between the electric generator 30′ and the second energy sensor circuit 120′. The cutoff switch 210 may be controlled by the main control module 32″. The power conversion circuit 14″ may further include one or more transformers 212, 214 coupled between the energy sensor circuits 118′, 120′ and the distribution circuit 20. The transformers 212, 214 may be used, for example, to drop down received voltage to a desired consumer distribution circuit voltage. In one example embodiment, the transformers 212, 214 drop down a received 240v power signal to a 120v power signal.

Table 1 provides a current comparison table for one example implementation of the of the power conversion circuit 14″. The sample implementation, includes the use of: a pulley ratio between the electric motor 28′ and the electric generator 30′ of 12:23; a three phase approximately 50 horse power (hp) electric motor having a pulley rotating at approximately 3600 revolutions per minute (rpm) is used for the electric motor 28′; and a three phase approximately 50 kW electric generator having a pulley rotating at approximately 1800 rpm is used for the electric generator 30′. The electric generator 30′ has a maximum output load or current draw of 140 Amps. Of course, the size of the electric motor 28′ and the electric generator 30′ may vary per application and power requirements thereof. In the example implementation, voltage potential across the legs L1-L3, L1′-L3′, L1″-L3″, and L1′″-L3′″ of the main power unit 18′, the motor drive circuit input 220, electric motor 28′, and the electric generator 30′, respectively, is the same and is 240v. For the example implementation, frequency of the current output of the electric generator 30′ is approximately 60 Hz.

TABLE 1
Example Current Comparison Table for Stages
of a Power Conversion Circuit

| | Current from | Current Draw by | Current Draw out of |
|---|---|---|---|
| Data Set | Main (A) | Electric Motor (B) | Electric Generator (C) |
| 1 | 7.5 Amps | 31 Amps | No Load - 0 Amps |
| 2 | 20 Amps | 38 Amps | 21 Amps |
| 3 | 24 Amps | 42 Amps | 25 Amps |
| 4 | 42 Amps | 56 Amps | 43 Amps |
| 5 | 60 Amps | 61 Amps | 60 Amps |
| 6 | 71 Amps | 81 Amps | 100 Amps |
| 7 | 80 Amps | 101 Amps | 140 Amps |

The current from the main power unit 18′ is designated as point A. The current draw by the electric motor 28′ is designated as point B. The current draw out of the electric generator 30′ is designated as point C. Note that since current flow through each of the legs L1-L3 is approximately the same, since current flow through each of the legs L1″-L3″ is approximately the same, and since current flow through each of the legs L1″-L3″ is approximately the same, current flow through L1, L1″, L1′″ is provided and designated points A, B, C.

For the embodiment associated with Table 1, note that current draw out of the electric generator 30′ is greater than the current received from the main power unit 18′ for data sets of columns 6 and 7. Thus, power draw from the main power unit 18′ is reduced, while power to the distribution circuit 20 is maintained. Power savings is provided when current draw on the electric generator 30′ is approximately 50%±5% of the maximum design load of the electric generator 30′. The amount of power savings increases as current draw on the electric generator 30′ approaches 100% of the maximum design load. Also, the rate of increase in power savings increases as current draw on the electric generator 30′ approaches 100% of the maximum design load. Therefore, the electric motor 28′ and the electric generator 30′ are activated after reaching at least a current draw of approximately 50%. This not only provides efficient use of the power conversion circuit 14″, but also minimizes wear on the electric motor 28′ and electric generator 30′.

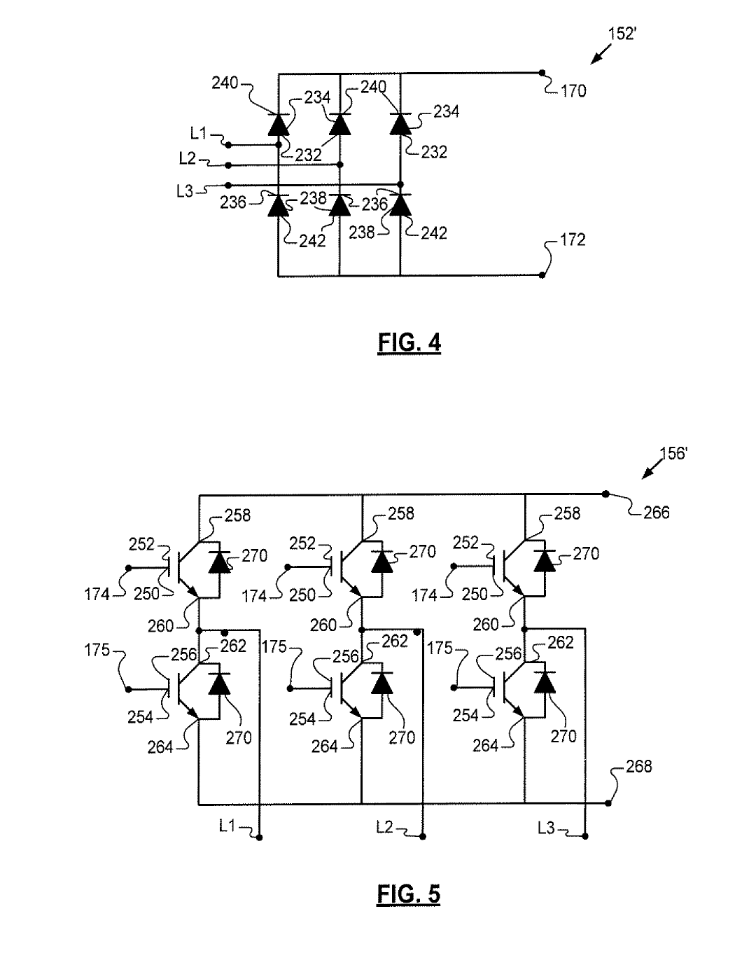

In the following FIGS. 4 and 5, example A/D and D/A converters are shown; other converters may be incorporated in the power conversion circuits disclosed in association with the embodiments herein.

Referring now to FIG. 4, a schematic view of an A/D converter 152′ is shown. The A/D converter 152′ includes three input legs L1-L3. Each input leg L1-L3 is coupled to an anode 232 of one of a first series of diodes 234 and a cathode 236 of one of a second series of diodes 238. Cathodes 240 of the first diodes 234 are coupled together at the positive A/D output terminal 170. Anode ends 242 of the second diodes 238 are coupled together at the negative A/D output terminal 172.

Referring now to FIG. 5, a schematic view of a D/A converter 156′ is shown. The D/A converter 156′ includes the positive and negative DC input terminals 174, 175. The positive input terminal 174 is coupled to base terminals 250 of a first set of three transistors 252. The negative input terminal 175 is coupled to base terminals 254 of a second set of three transistors 256. The first set of transistors 252 has collectors 258 and emitters 260. The second set of transistors 256 has collectors 262 and emitters 264. The collectors 258 are coupled together and to a first reference voltage terminal 266. The emitters 260 are coupled to the collectors 262 and provide AC output legs L1″-L3″. The emitters 264 are coupled to a second reference voltage terminal 268, such as ground. Diodes 270 are coupled across the collector and emitter terminals of each transistor 252, 256. Cathodes of the diodes 270 are coupled to the collectors 258, 262 and anodes of the diodes 270 are coupled to the emitters 260, 264, respectively.

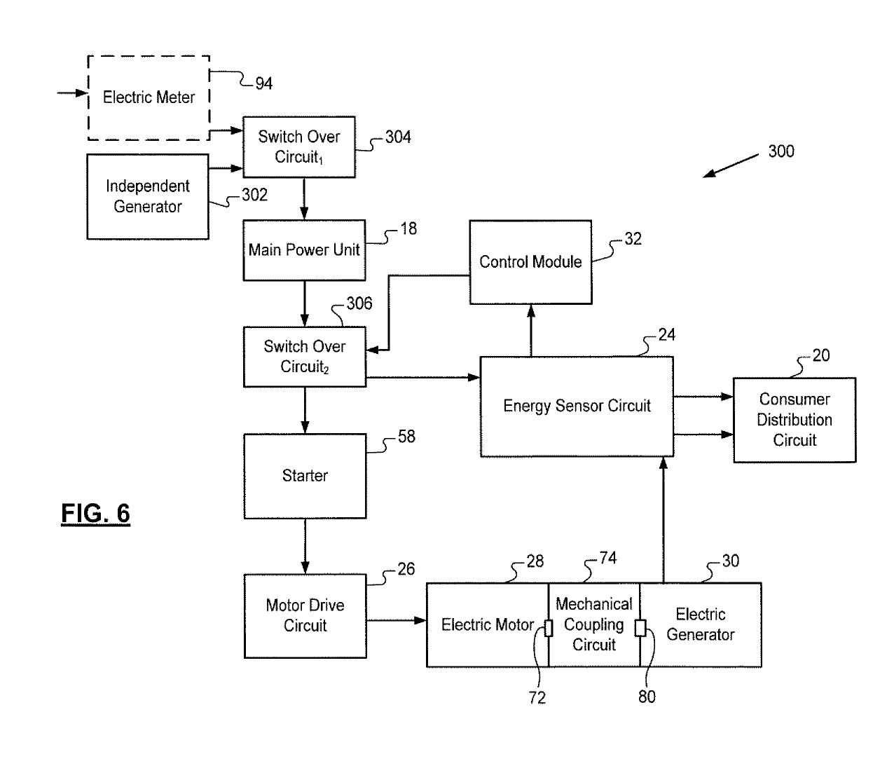

Referring now to FIG. 6, a functional block diagram of a power conversion system 300 incorporating an independent generator 302 is shown. The power conversion system 300 includes first and second switch over circuits 304, 306. The first switch over circuit 304 may be used to switch between the reception of metered power from a main power source, for example, a power line or local area power distribution network, or from the independent generator 302. The independent generator 302 may be for example an internal combustion engine that provides electrical power. The second switch over circuit 306 may be used to switch between providing power to the starter 58 and the energy sensor circuit 24.

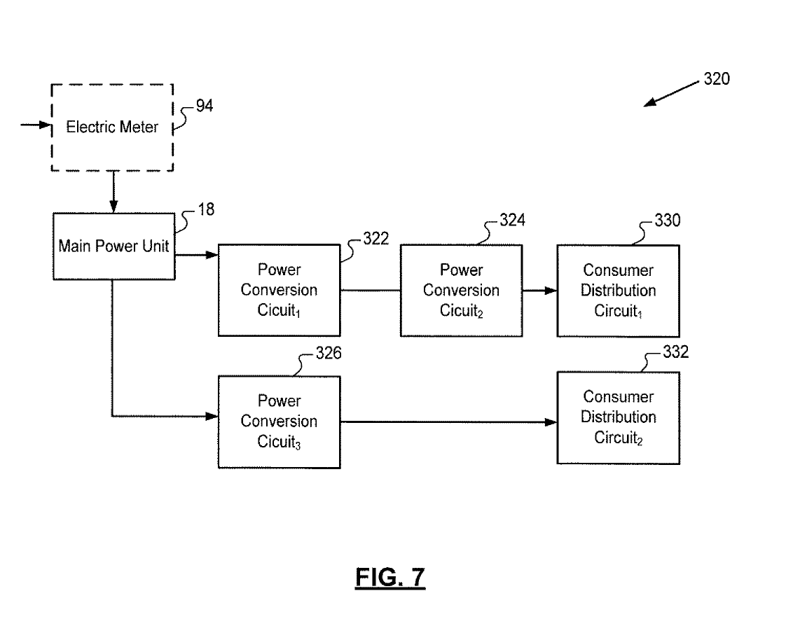

Referring now to FIG. 7, a functional block diagram of a multi-power conversion system 320 is shown. The power conversion system 320 includes multiple power conversion circuits 322, 324, 326. The power conversion circuits 322, 324, 326 may be coupled in series and/or in parallel and provide power to multiple consumer distribution circuits 330, 332. The consumer distribution circuits 330, 332 may be located within a single building or in multiple buildings. When the power distribution circuits 322, 324, 326 are coupled in series, the power savings may be increased over the use of a single power conversion circuit.

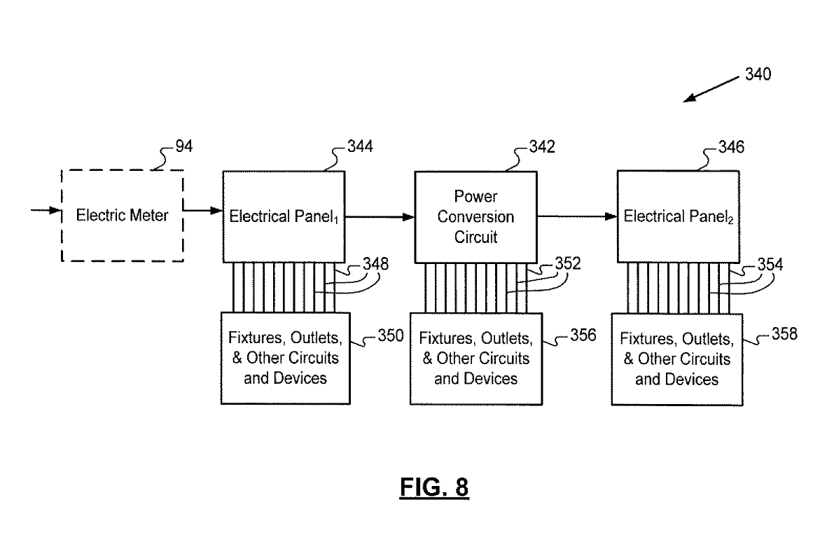

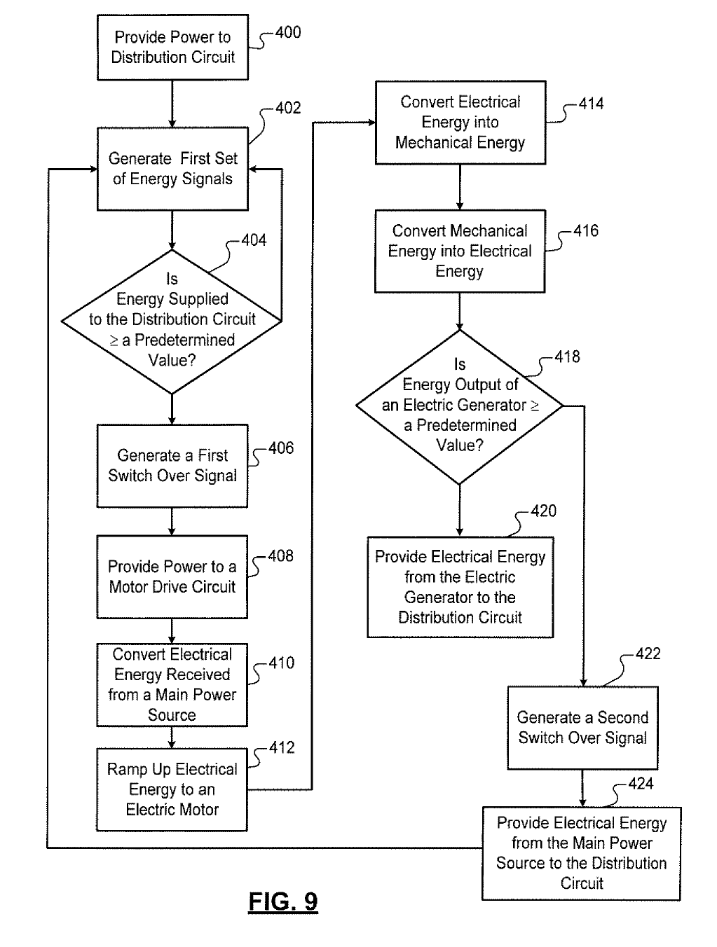

Referring now to FIG. 8, a functional block diagram of a consumer electrical power distribution network 340 with a portion thereof that incorporates a power conversion circuit 342 in accordance with another embodiment of the present disclosure. The distribution network 340 includes first and second electrical panels 344, 346. The first electrical panel 344 may receive metered power from a main power unit. The first electrical panel 344 provides power directly to a first set of circuits 348 that may have fixtures, outlets, and/or other electrical circuits and devices 350. The first electrical panel 344 also provides power to the power conversion circuit 342.

The power conversion circuit 342 may provide power directly to a second set of circuits 352 and/or to a second electrical panel 346. The second electrical panel 346 may provide power to a third set of electrical circuits 354. The second and third electrical circuits 352, 354 may include fixtures, outlets and other circuits and devices 356, 358, respectively. Note that any number of electrical panels and power conversion circuits may be incorporated, although a particular number of each is shown. The electrical panels and power conversion circuits may be coupled in various configurations, depending upon the application.

Referring to FIG. 9, a logic flow diagram illustrating a method of operating a power conversion system is shown. Although the following steps are described primarily with respect to the embodiment of FIG. 2, they may be easily modified to apply to other embodiments of the present invention.

In step 400, power is provided to one or more consumer distribution circuits, such as the distribution circuit 20. In step 402, the first energy sensor circuit 118 generates a first energy signal or set of energy signals. The energy signals may include a current signal or a power signal based on the load from the distribution circuit 20.

In step 404, the control module 32′ monitors electrical energy provided to the distribution circuit 20 and based thereon signals the switch over circuit 112. The main control module 32′ compares the first set of energy signals to predetermined load factors. When the energy supplied to the distribution circuit 20 is approximately greater than or equal to one or more predetermined values or load factors, the control module 32′ proceeds to step 406. In one embodiment, when the current supplied to the distribution circuit 20 is greater than or equal to a load factor of a maximum load capacity of the electric generator 30, the control module 32′ proceeds to step 406.

In another example embodiment, when the current supplied to the distribution circuit 20 is approximately equal to or greater than approximately 75% of a maximum load capacity of the electric generator 30, the control module 32′ proceeds to step 406. In yet another embodiment, when the current supplied to the distribution circuit 20 is approximately within approximately 95%-100% load capacity of the electric generator 30, the control module 32′ proceeds to step 406. When the energy supplied to the distribution circuit 20 is approximately less than a predetermined load, the control module 32′ returns to step 402.

In step 406, the control module 32′ generates a first switch over signal. The control module 32′ may monitor the ramping up of the electric motor 28 and generate the switch over signal after the electric motor 28 is ramped up to an appropriate speed. This minimizes power fluctuation on the distribution circuit 20.

In step 408, the switch over circuit 112 changes state based on the switch over signal. The switch over circuit 112 switches to provide power to the motor drive circuit 60, as opposed to the first energy sensor circuit 118.

In step 410, the motor drive circuit 60 converts a first electrical energy or power received from the switch over circuit 112 to generate a second electrical energy or power. In step 412, the motor drive circuit 60 ramps up and provides the second electrical energy to the electric motor 28.

In step 414, the electric motor 28 converts electrical energy into mechanical energy. In step 416, the electric generator 28 converts mechanical energy into electrical energy. In step 418, electrical energy from the electric generator 28 is provided to the second energy sensor circuit 120, which generates a second set of energy signals based thereon.

In step 420, the control module 32′ compares the second set of energy signals with the predetermined values or load factors. In step 422, the control module 32′ provides the electrical energy from the electric generator 30 to the distribution circuit 20 when the electrical energy is greater than or equal to the predetermined factors. In step 424, the control module 32′ generates a second switch over signal when the electrical energy is less than the predetermined factors. In step 426, the switch over circuit 112 switches to providing power to the distribution circuit 20 through the first energy sensor circuit 118, as opposed to the second starter 116 and then returns to step 402.

Due to the power savings associated with the above disclosed embodiments, residential, commercial and/or industrial applications and/or operations may now be feasible that were not otherwise feasible. For example and to name a small few: air conditioning may be operated for extended periods of time; increased lighting may be provided; additional machines may be operated; and architectural structures may be formed that were previously not considered due to heating and/or cooling costs.

Heating and cooling of a building is in general the single biggest electrical energy consumption area. Another large electrical energy consumption area is lighting. Some retailers argue that bright lighting stimulates purchasing. The power savings provided by the above disclosures may allow for increased lighting with lower overhead costs, which may allow retailers to provide lower prices, thus stimulating the economy.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A power conversion circuit comprising:
main terminals that receive a first electrical energy from a main power source;
an electric motor that has input terminals that are coupled to said main terminals, that receives a second electrical energy as a current input based on said first electrical energy, and that converts said electrical energy into mechanical energy to generate a mechanical output;
an electric generator that generates a current output, which is greater than or equal to said current input, based on said mechanical output, and
distribution terminals that are coupled to a distribution circuit of a building and that receive said current output,
wherein voltage across said input terminals is approximately equal to voltage across said distribution terminals.

2. The power conversion circuit of claim 1 further comprising a motor drive circuit that generates said second electrical energy based on at least a portion of said first electrical energy.

3. The power conversion circuit of claim 1 wherein said motor drive circuit comprises:
an alternating current (AC) to direct current (DC) converter that converts said first electrical energy into a DC signal; and
a DC-to-AC converter that converts said DC signal into an AC signal,
wherein said second electrical energy is based on said AC signal.

4. The power conversion circuit of claim 1 wherein said motor drive circuit comprises a starter that enables reception of said second electrical energy.

5. The power conversion circuit of claim 1 wherein said motor drive circuit comprises a control module that ramps up power associated with said current input based on said first electrical energy.

6. The power conversion circuit of claim 1 wherein said electric motor has an offload current rating, wherein load on said electric motor is approximately equal to said offload current rating plus one half of said current output.

7. The power conversion circuit of claim 1 further comprising a mechanical coupling assembly between said electrical motor and said electric generator.

8. The power conversion circuit of claim 7 wherein said mechanical coupling assembly has a pulley ratio between said electric motor and said electric generator of approximately 1:2.

9. The power conversion circuit of claim 1 further comprising a starter that enables flow of said first electrical energy to said electric motor.

10. A power conversion system comprising:
a power conversion circuit comprising:
a first switch over circuit that receives an electrical energy from a power source and that operates in a first mode and a second mode based on load of a first distribution circuit;
an electric motor that has input terminals, which receive at least a portion of said electrical energy as a current input when said first switch over circuit is in said first mode, and that converts said electrical energy into mechanical energy to generate a mechanical output;
an electric generator that generates a first current output, which is greater than or equal to said current input, based on said mechanical output; and
distribution terminals that are coupled to said first distribution circuit and that receive at least a portion of said electrical energy when said first switch over circuit is in said second mode.

11. The power conversion system of claim 10 wherein said distribution terminals receive said first current output when said first switch over circuit is in said first mode.

12. The power conversion system of claim 10 wherein said first switch over circuit operates in said first mode when said load is greater than or equal to a predetermined value.

13. The power conversion system of claim 10 wherein said first switch over circuit operates in said first mode when said load is greater than or equal to a load factor of a maximum load of said electric generator.

14. The power conversion system of claim 10 wherein said first switch over circuit operates in said first mode when said load is greater than or equal to at least approximately 50% of a maximum load of said electric generator.

15. The power conversion system of claim 10 further comprising a second power conversion circuit that generates a second current output based on said first current output.

16. The power conversion system of claim 10 further comprising a second power conversion circuit that is parallel to said first power conversion circuit, that generates a second current output based on a received a portion of said electrical energy, and that provides said second current output to a second distribution circuit.

17. The power conversion system of claim 10 further comprising a second switch over circuit that enables reception of said electrical energy from at least one of a main power source and an independent generator.

18. The power conversion system of claim 10 wherein said electrical energy is received from an electrical panel.

19. A power conversion circuit comprising:
a control module that generates a switch over signal based on load of a distribution circuit;
a switch over circuit that receives a first electrical energy from a main power source and that operates in a first mode and a second mode based on said switch over signal;
a motor drive circuit that generates a second electrical energy based on at least a portion of said first electrical energy when said switch over circuit is in said first mode;
an electric motor that has input terminals, which receive said second electrical energy as a current input, and that converts said second electrical energy into mechanical energy to generate a mechanical output;
an electric generator that generates a current output, which is greater than or equal to said current input, based on said mechanical output; and
distribution terminals that are coupled to said distribution circuit and that receive said first electrical energy, when said switch over circuit is in said second mode.

20. The power conversion circuit of claim 19 further comprising an energy sensor circuit that generates an energy signal based on said load, wherein said control module generates said switch over signal based on said energy signal.
